(19) United States
(12) Patent Application Publication
(10) Pub. No.: US 2025/0165238 A1
(43) Pub. Date: May 22, 2025

(54) SYSTEM AND METHOD FOR AI-SUPPORTED DEPLOYMENT OF COMPUTING ENVIRONMENTS

(71) Applicant: ROYAL BANK OF CANADA, Toronto (CA)

(72) Inventors: Kevin Xiaozeng JIANG, Toronto (CA); Manoj AGRAWAL, New York, NY (US)

(21) Appl. No.: 18/949,662

(22) Filed: Nov. 15, 2024

Related U.S. Application Data
(60) Provisional application No. 63/599,662, filed on Nov. 16, 2023.

(51) Int. Cl. G06F 8/60

(52) U.S. Cl. CPC G06F 8/60

(57) ABSTRACT

Disclosed herein are methods and systems for automated deployment of a computing environment. A natural language description of a target computing environment is received from a user. A follow-up question to the user regarding a requirement of the target computing environment is generated. The natural language description and a response to the follow-up question are transformed to a prompt for a generative model, the prompt requesting a deployment data structure defining deployment parameters of the target computing environment.

### CROSS-REFERENCE TO RELATED APPLICATION

This application claims the benefit of and priority to U.S. provisional patent application No. 63/599,662 filed Nov. 16, 2023, the entire content of which is herein incorporated by reference.

### FIELD

This disclosure relates to computing environments, and more particularly relates to deployment of computing environments.

### BACKGROUND

The advent of the Internet and especially cloud computing has revolutionized how businesses and individuals access and use computing resources. In but one example, infrastructure-as-a-Service (IaaS) has emerged as a fundamental service model for the supply of cloud infrastructure. Platforms such as Amazon Web Service (AWS)™, Microsoft Azure™, Google Cloud™, and the like, provide virtual machines, storage, networking, and other resources, allowing users to run applications and store data without the need to invest in and maintain physical hardware.

As the demand for computing resources continues to grow, challenges and limitations of existing platforms and tools for deploying computing resources have become evident, including complexities in their use and management. Accordingly, there is need for improved or alternate ways of assisting users in the deployment of computing resources.

### SUMMARY

In accordance with one aspect, there is provided a computer-implemented system for automated deployment of a computing environment. The system includes a processing subsystem that includes one or more processors and one or more memories coupled with the one or more processors, the processing subsystem configured to cause the system to: receive, from a user, a natural language description of a target computing environment; generate a follow-up question to the user regarding a requirement of the target computing environment; and transform the natural language description and a response to the follow-up question to a prompt for a generative model, the prompt requesting a deployment data structure defining deployment parameters of the target computing environment.

In some embodiments, the generative model includes a large language model (LLM), and the processing subsystem comprises a LLM controller configured to generate the prompt for the LLM based on an input template file.

In some embodiments, the LLM controller is configured to: generate the follow-up question based on the input template file; generate the prompt based on the input template file; send the prompt to the LLM for requesting the deployment data structure defining deployment parameters of the target computing environment; and upon receipt of an output file comprising the deployment data structure from the LLM, send the output file to a computing environment management system for deployment of the target computing environment.

In some embodiments, the input template file is in YAML format.

In some embodiments, the output file is in YAML format.

In some embodiments, the LLM controller comprises a multi-agent controller configured to, in an iterative process, generate a sequence of questions to the user based on the input template file and one or more responses from the user.

In some embodiments, the target computing environment is one of: a cloud environment, a programmatically-deployable environment, or an on-premise environment.

In some embodiments, the processing subsystem is further configured to cause the system to provide the deployment data structure to a computing environment management system for deployment of the target computing environment.

In some embodiments, the processing subsystem is further configured to cause the system to: compare an estimated cost for the deployment of the target computing environment to a predefined cost threshold; and when the estimated cost is within the predefined cost threshold, cause a computing environment management system to deploy the target computing environment based on the deployment data structure.

In some embodiments, the generative model includes a transformer model.

In some embodiments, the processing subsystem is further configured to cause the system to generate a plurality of follow-up questions.

In some embodiments, the plurality of follow-up questions include a sequence of questions wherein a subsequent question in the sequence of questions is generated based on the user's response to a prior question in the sequence of questions.

In accordance with another aspect, there is provided a computer-implemented method for automated cloud deployment of a computing environment. The method includes: receiving, from a user, a natural language description of a target computing environment; generating a follow-up question to the user regarding a requirement of the target computing environment; and transforming the natural language description and a response to the follow-up question to a prompt for a generative model, the prompt requesting a deployment data structure defining deployment parameters of the target computing environment.

In some embodiments, the generative model includes a large language model (LLM), and the method further comprises: executing a LLM controller to generate the prompt for the LLM based on an input template file.

In some embodiments, executing the LLM controller comprises: generating the follow-up question based on the input template file; generating the prompt based on the input template file; sending the prompt to the LLM for requesting the deployment data structure defining deployment parameters of the target computing environment; and upon receipt of an output file comprising the deployment data structure from the LLM, sending the output file to a computing environment management system for deployment of the target computing environment.

In some embodiments, the input template file is in YAML format.

In some embodiments, the LLM controller includes a multi-agent controller, and the method comprises, in an iterative process, generating a sequence of questions to the user based on the input template file and one or more responses from the user.

In some embodiments, the target computing environment is one of: a cloud environment, a programmatically-deployable environment, or an on-premise environment.

In some embodiments, the method may include: providing the deployment data structure to a computing environment management system for deployment of the target computing environment.

In some embodiments, wherein the generative model includes a transformer model.

In some embodiments, the method may include: generating a plurality of follow-up questions.

In some embodiments, the method may include: generating the plurality of follow-up questions based on an input template file.

In some embodiments, the input template file is in YAML format.

In some embodiments, the plurality of follow-up questions include a sequence of questions, wherein a subsequent question in the sequence of questions is generated based on the user's response to a prior question in the sequence of questions.

In some embodiments, the deployment data structure is in a human-readable format.

In some embodiments, the deployment data structure is in a JSON format.

In some embodiments, the method may include: comparing an estimated cost for the deployment of the target computing environment to a predefined cost threshold; and when the estimated cost is within the predefined cost threshold, causing a computing environment management system to deploy the target computing environment based on the deployment data structure.

In some embodiments, the method may include: providing the deployment data structure to a computing environment management system for deployment of the desired computing environment.

In some embodiments, the method may include: generating the deployment data structure using the generative model.

In some embodiments, generating the deployment data structure includes: comparing the deployment pattern defined by the deployment data structure against a library of pre-approved patterns.

In some embodiments, generating the deployment data structure includes: comparing the deployment pattern defined by the deployment data structure against a pre-defined deployment policies.

In accordance with a further aspect, there is provided a non-transitory computer-readable medium or media having stored thereon machine interpretable instructions which, when executed by a processing system, cause the processing system to perform a method for automated deployment of a computing environment. The method includes: receiving, from a user, a natural language description of a target computing environment; generating a follow-up question to the user regarding a requirement of the target computing environment; and transforming the natural language description and a response to the follow-up question to a prompt for a generative model, the prompt requesting a deployment data structure defining deployment parameters of the target computing environment.

Many further features and combinations thereof concerning embodiments described herein will appear to those skilled in the art following a reading of the instant disclosure.

### BRIEF DESCRIPTION OF THE FIGURES

In the Figures,

FIG. 1 is a network diagram of a network environment of a computing environment deployment system, in accordance with an embodiment;

FIG. 2A is high-level schematic diagram of the computing environment deployment system of FIG. 1, in accordance with an embodiment;

FIG. 2B is another high-level schematic diagram of the computing environment deployment system of FIG. 1, in accordance with an embodiment;

FIG. 3 is a system flow diagram of the computing environment deployment system of FIG. 1, in accordance with an embodiment;

FIG. 4, FIG. 5, and FIG. 6 each is an example screen depicted to a user of the computing environment deployment system of FIG. 1, in accordance with an embodiment;

FIG. 7 is a schematic diagram of a computing device, in accordance with an embodiment;

FIG. 8 is a schematic flowchart illustrating an example workflow of an example multi-agent controller, in accordance with an embodiment; and

FIGS. 9 and 10 show an example budget cost definition as stored in an electronic datastore, in accordance with an embodiment.

These drawings depict exemplary embodiments for illustrative purposes, and variations, alternative configurations, alternative components and modifications may be made to these exemplary embodiments.

### DETAILED DESCRIPTION

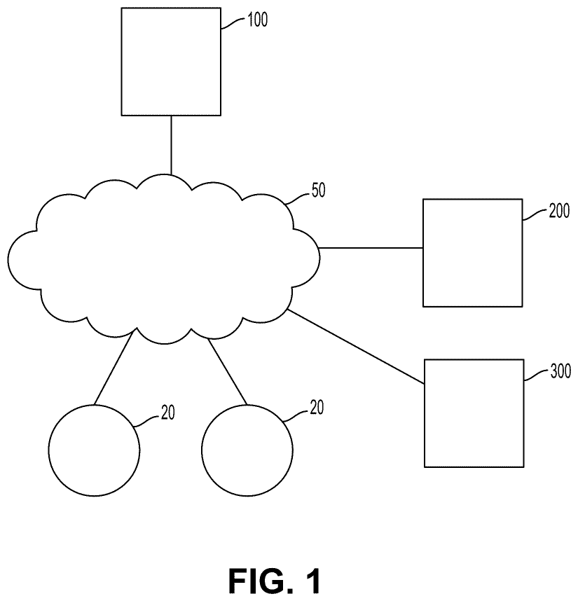

FIG. 1 is a network diagram depicting a network environment of a computing environment deployment system 100, an artificial intelligence (AI) system 200, a computing environment management system 300, and a plurality of user devices 20, interconnected by a communication network 50, in accordance with an embodiment. These systems and devices cooperate in manners disclosed herein to facilitate automated deployment of computing environments.

In some embodiments, a computer environment is deployed based on a user's natural-language description of a target computer environment. In some embodiments, computing environment deployment system 100 and AI system 200 cooperate to generate a data structure defining the target computer environment, which can then be used by computing environment management system 300 to deploy the target computer environment.

In some embodiments, computing environment deployment system 100 and/or AI system 200 enhance the user's initial description by generating at least one follow-up question regarding requirement(s) of the target computer environment and processing the response(s). In some embodiments, computing environment deployment system 100 performs prompt engineering using the initial description and the response(s) to generate a prompt to the AI system 200 to request a data structure defining the required computer environment.

Conveniently, in some embodiments, the systems and methods disclosed herein may achieve one or more of the following technical effects: the target computing environment may be provisioned more quickly, more efficiently (requiring fewer cloud resources), deployed with less assistance from specialist technicians, deployed in compliance with pre-approved patterns and/or policies, etc.

Each user device 20 is a device operable by a user to interact with a web application provided at computing environment deployment system 100. In some embodiments, the web application provides one or more user interfaces configured to receive user input including, e.g., a natural language description of a target computing environment, and response(s) to follow-up question(s) regarding requirements of the target computing environment. In some embodiments, the web application provides one or more user interfaces configured to present these questions and other outputs of computing environment deployment system 100 and AI system 200. Accordingly, each user device 20 is configured to execute a conventional web browser (e.g., Google Chrome, Apple Safari, Mozilla Firefox, or the like) for accessing the web application via a suitable protocol (e.g., HTTP, HTTPS, or the like).

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPV4, IPV6, X.25, IPX or similar network. Portions of network 50 could be, for example, a GSM, GPRS, 3G, LTE, 5G or similar wireless networks. Network 50 may include or be connected to the Internet. When network 50 is a public network such as the public Internet, it may be secured as a virtual private network (VPN).

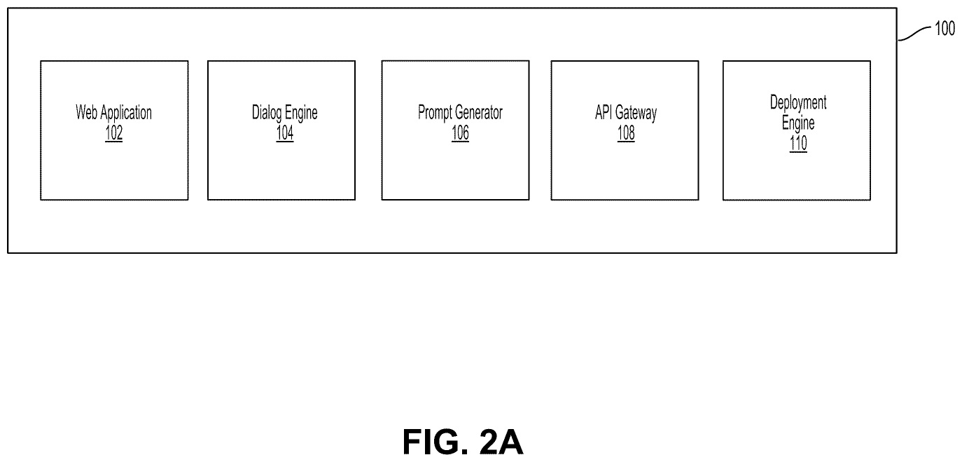

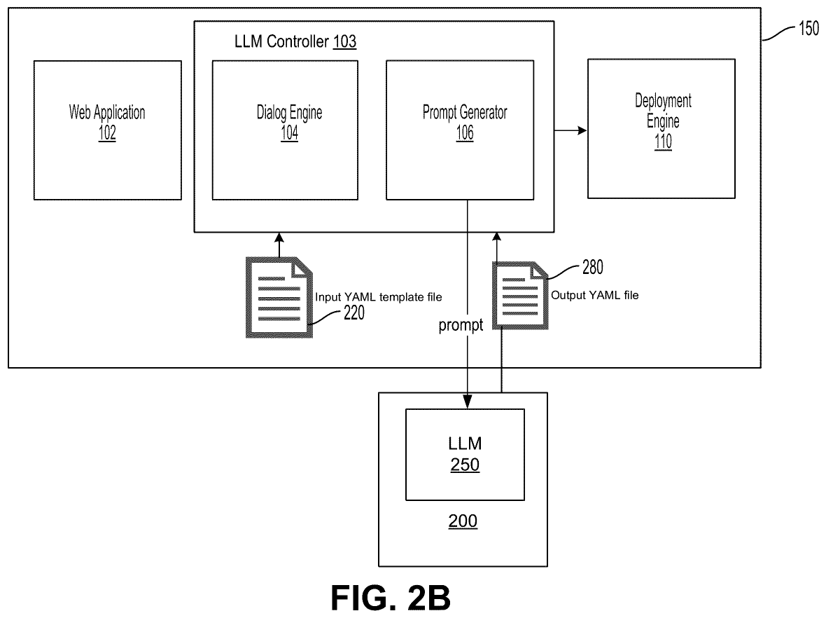

FIG. 2A is a high-level schematic diagram of computing environment deployment system 100, in accordance with an embodiment. As depicted, deployment system 100 includes a web application 102, a dialog engine 104, a prompt generator 106, an API gateway 108, and a deployment engine 110.

In the depicted embodiment, computing environment deployment system 100 is configured for deployment of cloud infrastructure via an IaaS platform. However, in some embodiments, the methods and systems disclosed herein may be used with other types of platforms and services such as those deployable as a Platform-as-a-Service (PaaS), Software-as-a-Service (SaaS), Data-as-a-Service (DaaS), a custom service, or the like. Further, in some embodiments, the methods and systems herein may be used to deploy various types of computing resources such as virtual machines, storage, databases, data lakes, firewalls, or the like. Further, in some embodiments, the methods and systems herein may be used to deploy other types of computing environments such as non-cloud computing environments such as, for example, “on premises” environments. In various embodiments, the methods and systems disclosed herein may be used to deploy an API-based environment or another type of programmatically-deployable environment such as a resource environment, an application/model runtime environment, or the like.

In some embodiments, computing environment deployment system 100 is configured for deployment of cloud infrastructure at enterprise level, with extended capabilities to deploy the cloud infrastructure in compliance with various regulations, policies, governance rules, and other types of controls that are necessary or appropriate for an enterprise entity user.

For example, a government entity user may require a cloud infrastructure to maintain security, confidentiality and integrity of private information, which may require the cloud infrastructure to be deployed with certain levels of network firewalls and other types of safeguards.

For another example, a financial institution or merchant user may require a cloud infrastructure to store cardholder data in a secure manner to minimize risks of data breaches, unauthorized access of said cardholder data, or identity theft. This may require the cloud infrastructure to be in compliance with specific regulations such as Payment Card Industry Data Security Standard (PCI-DSS).

As yet another example, a hospital entity user may require a cloud infrastructure to interface with a variety of IT systems, both legacy and new, in order to receive and transmit patient and other medical data to related or external entities in a secure and efficient manner. Such a cloud infrastructure usually requires technical integration capabilities with other IT systems, and may be expensive to build and maintain. The hospital entity user may also need to ensure that the cloud infrastructure, once properly deployed, can be within a certain budget limit.

In above scenarios, computing environment deployment system 100 can be customized to plan and deploy the appropriate cloud infrastructure at enterprise level, with extended capabilities effectuated by technical implementation of computing environment deployment system 100, as described below.

Web application 102 is configured to provide one or more interactive user interfaces, accessible by a user operating a user device 20. For example, web application 102 may include a front-end implemented using a suitable combination of HTML, CSS, Javascript code, or the like, and accessible via a web browser executing at a user device 20.

The interactive user interfaces provided at web application 102 include a user interface for the user to provide a natural language description of a target cloud infrastructure.

Initial description of a target computer environment can be received by system 100 from user device 20 in natural language, through one or more user interfaces of web application 120. For instance, one example user interface may include one or more graphical user interface (GUI) elements on a web-based HTML page provided by web application 120 that receives user input in text form. Another example user interface provided by web application 120 may be configured to receive user input in audio form via microphone device connected to user device 20.

Initial description of the target computer environment in natural language may include one or more goals, properties or requirements for the target computer environment as desired by the user. The interactive user interfaces provided at web application 102 include a user interface for engaging the user in follow-up questions to draw out from the user further requirements of the target cloud infrastructure, and includes appropriate input elements for the user to respond to the questions (e.g., text entry fields, checkboxes, radio buttons, or the like).

In some embodiments, web application 102 is configured to present one or more questions under the control of dialog engine 104.

Dialog engine 104 is configured to generate one or more follow-up questions based on an initial description of the target cloud infrastructure received from the user. Each question is generated to refine and/or clarify the requirements of the target cloud infrastructure. In some cases, a question may request that the user describe a particular architecture, deployment pattern, and/or IaaS platform to be used. In some cases, a question may present deployment options, and ask the user to select one or more of the options. In some cases, a question may present costs, wait times, risks, or the like, and ask the user to provide acknowledgement. In some cases, dialogue engine 104 may generate a question based on information provided by deployment engine 110, e.g., information regarding estimated costs, information regarding available patterns, deployment constraints, etc. In some cases, dialogue engine 104 may generate a question based on information provided by AI system 200. For example, AI system 200 may seek follow-up information, which may be included by dialogue engine 104 (with or without modification) in the questions posed to the user.

In some embodiments, when there are multiple follow-up questions, these questions may be presented in a sequence wherein a subsequent question is generated by dialog engine 104 based on at least one response to a prior question.

Prompt generator 106 is configured to generate a prompt for a generative model of AI system 200. The prompt instructs the generative model to generate a data structure defining a deployment of cloud infrastructure. Prompt generator 106 utilizes the initial description of the target cloud infrastructure received from the user. Prompt generator 106 may also utilize at least one response to the question(s) generated by dialog engine 104. In this way, prompt generator 106 enhances or supplements the initial description using additional information included in the at least one response. In this way, prompt generator 106 transforms the initial description and the at least one response into a prompt for a generative model of AI system 200.

Prompt generator 106 is configured to, based on real time user input, generate and output a prompt to request, from the generative model, a suitable deployment data structure defining deployment parameters of the target computing environment. In some embodiments, the generated prompt may be configured to instruct the generative model to generate a suitable deployment data structure defining deployment parameters of the target computing environment. The prompt can be in a particular format, such as the JSON format. In some embodiments, other formats may be used, e.g., XML, YAML, or the like.

In some embodiments, prompt generator 106 is configured to generate the prompt to instruct the generative model to create the deployment data structure using a particular declarative language, e.g., as may be understood by computing environment management system 300 or another downstream component that uses the data structure in the provisioning of the defined cloud infrastructure.

Referring now to FIG. 2B, which shows another high-level schematic diagram of a computing environment deployment system 150. In some embodiments, the deployment data structure may be presented in an output file 280 generated by a generative model, such as a LLM model 250, under the orchestration of a LLM Controller 103 based on a input template file 220.

In some embodiments, input template file 220 and output file 280 may be in YAML format.

In some embodiments, as depicted in FIG. 2B, LLM Controller 103 is trained to interact with a user device via web application 120 in real time or near real time to generate the output YAML file 280 defining the suitable deployment data structure. The real time interaction with user may include one or more questions based on a list of given fields in a template YAML file. For example, LLM Controller 103 may include: 1) dialog engine 104 to receive and process user input, including initial user request and user-provided answers to one or more questions, in natural language, and; 2) prompt generator 106 to produce a prompt based on the processed user input from dialog engine 104. LLM Controller 103 may use the prompt to instruct a generative model, such as a LLM 250, to generate the output YAML file 280 for defining the deployment data structure based on one or more prompts generated by prompt generator 106.

An example input YAML template file 220 is shown below.

```
app_code:
  data_type: string
  description: The App Code of the client application, for resource
naming and tagging. When leaving it to default, module will use
the App Code from the registry. You only need to provide a custom
value when you want to override the one from the registry.
  default: “”
app_name:
  data_type: string
  description: “Application name”
  default: “”
branch:
  data_type: string
  description: “The branch name for AKV.”
  default: “”
compliance:
  data_type: string
  description: “corporation data compliance of the client
application, for resource tagging.”
  default: “N/A”
  selections: [“N/A”, “sox1”, “sox2”, “sox3”, “pci”]
create_resource_locks:
  data_type: bool
  description: “Create resource locks for provisioned Key Vault
entities”
  default: false
data_classification:
  data_type: string
  description: “Data classification (internal, public, etc.)”
  required: true
  default: “internal”
  selections: [“internal”, “confidential”, “public”, “restricted”,
“sensitive”]
deployment_number:
  data_type: number
  description: “The deployment number.”
  default: 1
dr_configuration:
  data_type: object
  description: “The configuration of the DR settings. When the
information is provided, the module will creates a DR private
endpoint in the given virtual network and subnet, also within the
same region of the given virtual network and subnet”
  default: null
  fields:
    dr_virtual_network_resource_group_name:
      data_type: string
    dr_virtual_network_name:
      data_type: string
    dr_private_endpoint_subnet_name:
      data_type: string
environment:
  data_type: string
  description: “Environment”
  default: “”
  selections: [“dev”, “uat”, “qat”, “prod”]
extra_tags:
  data_type: map
  description: “User provided extra tags that should be applied
along with the required ones.”
key_vault_name:
  data_type: string
  description: “The name of KevVault.”
  default: “”
location:
  data_type: string
  description: “Location of the resource”
  default: “canadacentral”
network_acls:
  data_type: object
  description: “Object with attributes: bypass, default_action,
ip_rules, virtual_network_subnet_ids.”
  default: null
  fields:
    bypass:
      data_type: string
    default_action:
      data_type: string
    ip_rules:
      data_type: array
      elements:
        data_type: string
    virtual_network_subnet_ids:
      data_type: array
      elements:
        data_type: string
```

In some embodiments, LLM Controller 103 may include a LangChain agent configured to collect user input in said real-time user interaction and generate appropriate questions, based on the input YAML template file, to collect the necessary data required to generate one or more prompts.

API gateway 108 is configured to manage user access, via computing environment deployment system 100, to an API of AI system 200. API gateway 108 receives an API request from web application 102. In response to this request, API gateway 108 checks user permissions to ensure that the particular user seeking to access the API has valid permissions to do so. Further, in response to this request, API gateway 108 tracks the usage by the particular user to calculate and assign a monetary cost to the user for accessing the API. If the particular user has appropriate permissions, API gateway 108 makes the API request to AI system 200.

Deployment engine 110 is configured to process a data structure defining a deployment of a cloud infrastructure to ensure that it is compliant with pre-defined deployment rules, constraints, and/or policies. These constraints may, for example, relate to a maximum cost (e.g., budget), a maximum storage size, or the like. Such rules, constraints, and/or policies may include those associated with a particular organization (e.g., to which the user belongs), associated with a particular customer, associated with a particular IaaS platform, or the like.

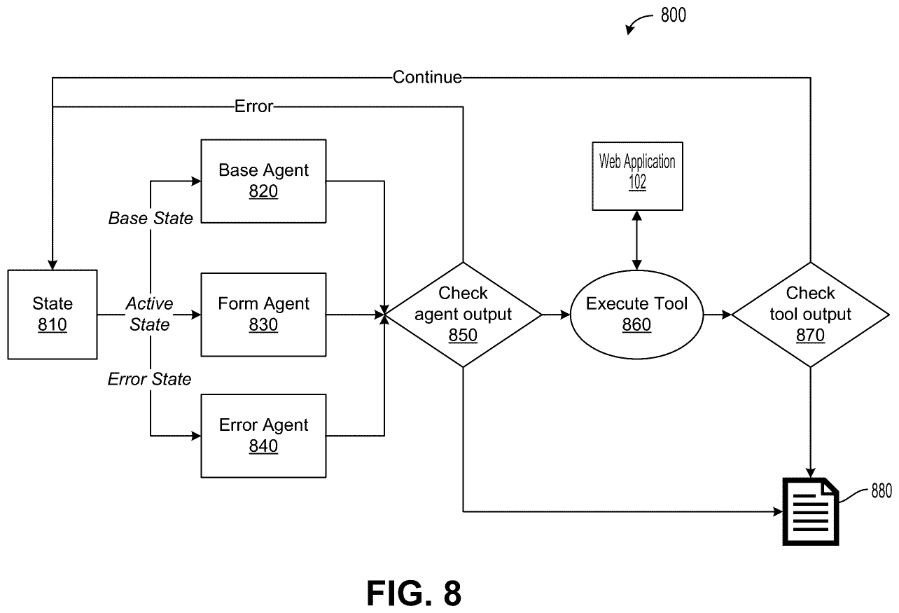

In some embodiments, a LLM controller 103 may be implemented as a multi-agent controller configured to, in an iterative process, generate a sequence of questions to the user based on an input template file and a prior user input, which may include an initial description of the target computing environment, or one or more user responses. FIG. 8 shows a schematic workflow 800 of an example multi-agent controller that may be implemented as part of LLM controller 103 for providing an output file defining the deployment data structure based on one or more user input received from web application 120.

At operation 810, multi-agent controller checks a state status of a form tool that is implemented by multi-agent controller for gathering user input via interface provided by web application 120. The form tool may be in one of three states: inactive, active and filled. Inactive state means that the form tool has not been activated yet and the multi-agent controller is free to start a user conversation with user device 20. Active state means that the form tool is currently in an active session with user device 20, and one or more questions may be sent to user device 20 via web application 120. Filled state means that the form tool has gathered all required data for generating the output file and user confirmation may be solicited to confirm the deployment data structure.

In some embodiments, depending on a current state of form tool, multi-agent controller may execute one or more agents, including for example base agent 820, form agent 830 and error agent 840, for providing an output file defining the deployment data structure based on one or more user input received from web application 120.

Base agent 820 can be executed to: return a state value of the form tool representing a current state of the form tool, manage the other agents including form agent 830 and error agent 840, and communicate with a generative model (e.g., LLM 250) for generation of an output file 880. In some embodiments, base agent 20 stores a copy of all history dialog with user device 20 regarding a specific target computing environment on a local datastore. Base agent 820 is responsible for managing the generative model to generate one or more questions including an initial question and any follow-up questions based on an input template file (e.g., input YAML template file), in order to gather sufficient data for generation of an output YAML file. For example, base agent 820 can be executed for generation of one or more prompts based on the user input, and sending the one or more prompts to the generative model for requesting the output YAML file defining the deployment data structure.

Form agent 830 can be executed to process different templates, including the input YAML template file, and routes the processed content to base agent 820 for further generation of any follow-up questions or prompts. Form agent 830 can also be executed to collect and process user input from the form tool, then routes the processed user input to base agent 820 and error agent 840 for further application.

Error agent 840 can be executed to examine user input sent by form agent 830 and determine if one or more errors exist. For example, error agent 840 can determine, based on a most recent user input, that a value or condition provided by the user is not compatible with an expected value or condition in the input template file, and thus returns an error code representing so.

At operation 850, multi-agent controller checks output from each of base agent 820, form agent 830 and error agent 840, if an error is found, for example, if error agent 840 returns an output indicating an error exists, multi-agent controller returns to operation 810 to check for a current state via base agent 820, and continues the iterative process.

If no error is found, multi-agent controller instructs form agent 830 to execute the form tool at operation 860, which causes web application 120 to gather all user input from one or more user interfaces, and if applicable, also presents one or more questions to user device 20. The one or more questions can be provided by base agent 820 based on a previous iteration of user input processing. For example, base agent 820 can instruct the generative model to generate the questions crafted to elicit appropriate user input in order to generate the output YAML file defining the deployment data structure, based on the input YAML template file.

User input from form tool, as collected by form agent 830, is then used by base agent 820 to determine one or more prompts, and the prompts may be sent to the generative model to generate one or more values or parameters for completing the output YAML file. The final output file 880 from multi-agent controller may be an output YAML file defining the defining the deployment data structure. Output file 880 may be routed to a computing environment management system to deploy the target computing environment based on the deployment data structure.

As described above, deployment engine 110 is configured to process the deployment data structure defining a deployment of a cloud infrastructure to ensure that it is compliant with pre-defined deployment rules, constraints, and/or policies. These constraints may, for example, relate to a maximum cost (e.g., budget), a maximum storage size, or the like. In some embodiments, deployment engine 110 is configured to compare an estimated cost for the deployment of the target computing environment to a predefined cost threshold; and when the estimated cost is within the predefined cost threshold, causing a computing environment management system to deploy the target computing environment based on the deployment data structure.

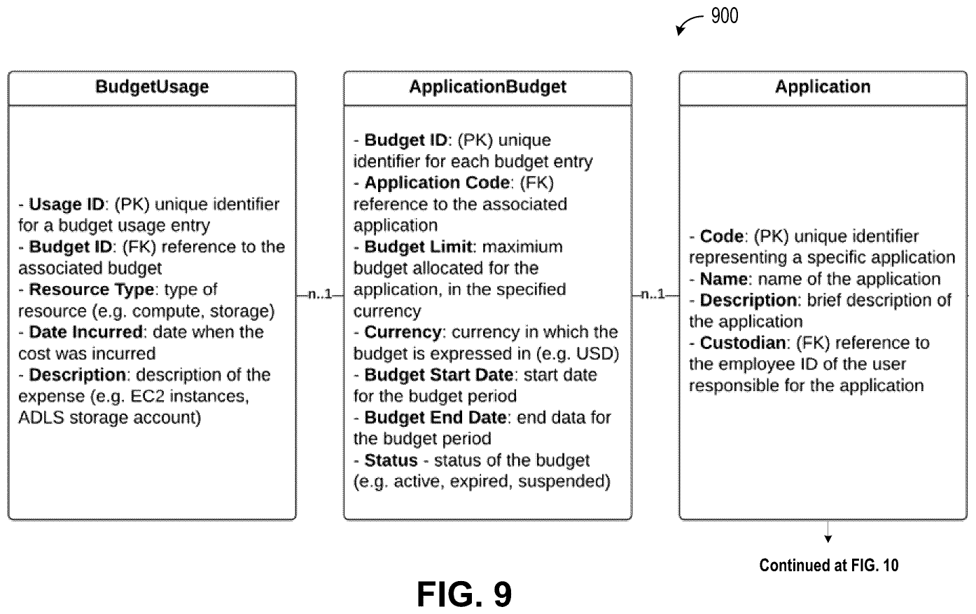

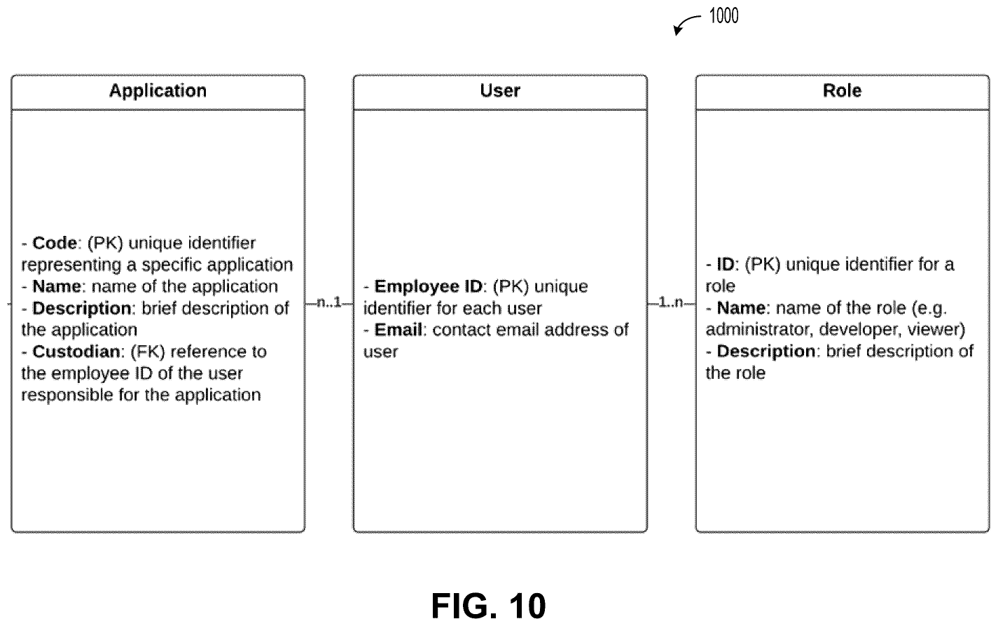

In some embodiments, deployment engine 110 may, based on the output file 280, 880 from LLM controller or multi-agent controller, perform a pre-deployment validation operation to ensure that the deployment of the target computing environment will be in compliance with one or more predefined rules, which are shown in FIGS. 9 and 10.

In some embodiments, a cost policy file is stored in local electronic datastore for automated implementation of pre-deployment cost control for deployment of a large computing environment. For example, deployment engine 110 may generate an estimated cost for deployment of the target computing environment using the data structure in output file 280, 880 as part of a pre-deployment validation operation; and only when the estimated cost is within a predefined cost threshold, which may be stored as part of cost policy file in a local electronic datastore, deployment engine 110 may proceed to instruct a computing environment management system to deploy the target computing environment based on the deployment data structure, in a deployment phase.

In some embodiments, a budget limit can be predefined in an existing cost policy stored locally, or can be predefined as a fixed value. As part of a pre-deployment validation operation in a planning phase, deployment engine 110 may generate an estimated cost for deployment of the target computing environment using the data structure in output file 280, 880. For example, deployment engine 110 may execute a block of code to calculate a respective cost for each type of resources required, based on a total number of each type of resources and a unit cost (e.g. hourly rate) for each type of resources. The total estimated cost may be a sum of respective costs for all types of resources required where applicable.

An example script illustrating an example pre-deployment validation operation is provided below.

```
import “tfplan”
import “json”
// Define budget limit for the application (this could be fetched
dynamically)
budget_limit = 5000.00 // Example budget in USD
# Function to calculate the estimated cost
cost_estimate(resource) {
  # Assume a simple mapping of instance type or storage units for
demonstration
  if resource.type == “aws_instance” {
    if resource.change.after[“instance_type”] == “t2.micro” {
      return 0.0116 * 730 // Cost estimation logic, e.g., hourly
rate * hours per month
    } else if resource.change.after[“instance_type”] == “m5.large” {
      return 0.096 * 730
    }
  }
  # Add logic for other resource types...
  return 0.0
}
# Calculate the total estimated cost of planned resources
total_estimated_cost = sum([cost_estimate(r) for r in
tfplan.resources if r.change.after])
# Policy enforcement
main = rule {
  total_estimated_cost <= budget_limit
        }
```

In some embodiments, deployment engine 110 is configured to provide information regarding estimated costs, information regarding available patterns, deployment constraints, or the like, based on the user's input. Deployment engine 110 may provide some or all of such information to dialogue engine 104, as requested. In some embodiments, deployment engine may obtain some of this information (e.g., estimated costs) from computing environment management system 300.

In some embodiments, information regarding estimated costs provided by deployment engine 110 may include estimations of a computing environment's operational costs including historical costs and forecasts. In some embodiments, deployment engine 110 may be configured to provide recommendations of available and preferred options, e.g., based on relative costs, trends, etc.

In some embodiments, computing environment deployment system 100 may be configured to provision monitoring capabilities in connection with a deployed computing environment, e.g., for validation against enterprise security policies and risk guidelines. Computing environment deployment system 110 may suggest such monitoring capabilities to a user for confirmation prior to deployment.

In some embodiments, computing environment deployment system 100 may be configured to provide to a user recommendations of enhancements, supplements, or improvements to a target computing environment, as described by a user. An example enhancements may be, for example, architectural enhancements. For example, computing environment deployment system 110 may compare the target computing environment, as described by a user, with similar successful implementations and suggest complementary components.

Each of web application 102, dialog engine 104, prompt generator 106, API gateway 108, and deployment engine 110 may be implemented using conventional programming languages such as Java, J #, C, C++, C#, Perl, Visual Basic, Ruby, Scala, etc. These components of computing environment deployment system 100 may be in the form of one or more executable programs, scripts, routines, statically/dynamically linkable libraries, or the like.

In some embodiments, computing environment deployment system 100 may include a conventional web server for that uses HTTP, HTTPS, and/or other suitable protocols to provide access to web application 102 and related content data.

In some embodiments, AI system 200 is configured to generate a deployment data structure (also referred to as “data structure”) defining a deployment of the cloud infrastructure.

In the depicted embodiment, AI system 200 includes the Azure Cognitive Services™ platform with Open AI integration. In this embodiment, AI system 200 includes a generative model configured to generate a data structure defining a cloud computing environment deployment pattern. The generative model may include, for example, a transformer model configured to generate the data structure based on a prompt, e.g., as generated by prompt generator 106. In some embodiments, this prompt is a human-readable text prompt. In some embodiments, this prompt may include a combination of text and image data. In some embodiment, the generative model may include a GPT-3 model, a GPT-3.5 model, a GPT-3.5-Turbo model, a GPT-4 model, or the like. In other embodiments, the generative model may include another large language model (LLM).

In some embodiments, the generative model is trained with relevant data for a particular organization, e.g., a particular organization operating computing environment deployment system 100. In some embodiments, the generative model is trained with data relevant for a particular client or clients, e.g., as serviced by a particular organization operating computing environment deployment system 100. Such data may be supplementary to pre-training performed on the generative model.

In the depicted embodiment, the relevant data includes deployment patterns for previously deployed cloud infrastructure projects, e.g., as approved by a particular organization or particular client(s). In some embodiments, the relevant data may be obtained automatically, e.g., by a script or command configured to gather project data from an IaaS platform (e.g., all Azure™ subscription of a particular organization). In some cases, the relevant data may be limited to production projects. In some cases, the relevant data may also include non-production (in development) projects. In the depicted embodiment, the Azure Cognitive Services™ platform is configured to ingest the relevant data into one or more of its generative models, e.g., via Azure™ OpenAI Studio or via an ingestion API.

In the depicted embodiment, AI system 200 maintains an electronic datastore containing a library of previously approved deployment patterns and/or deployment policies, which can be organized by those approved for production projects and those approved for non-production projects. In this embodiment, AI system 200 may compare a deployment pattern as defined in a deployment data structure automatically generated by its generative model against approved patterns and/or policies to confirm that the generated deployment pattern is approved or likely to be approved by deployment engine 110. In some embodiments, AI system 200 may be configured to generate a deployment data structure with a particular deployment pattern, but limit its use to non-production projects, e.g., if that deployment pattern has only been approved for non-production projects.

In some embodiments, data relating to previously deployed deployment patterns and services may be stored in an electronic datastore, which may be a local datastore or a cloud-based datastore. In some embodiments, data relating to previously deployed deployment patterns and services may be obtained automatically, e.g., by a script or command (e.g., a JSON command) configured to gather a list of accounts for a particular organization and all relevant data relating to previously deployed deployment patterns and services under said list of accounts. An Azure Cognitive Services™ platform may be configured to ingest the relevant data into one or more of its generative models, e.g., via Azure™ OpenAI Studio or via an ingestion API. In some embodiments, said services may include AWS™ services used by accounts in said list of accounts.

Computing environment management system 300 is configured to provision cloud infrastructure using one or more IaaS platforms based on requirements specified in a data structure, in accordance with an embodiment. Computing environment management system 300 interfaces with one or more IaaS platforms, allowing users to deploy cloud infrastructure using AWS™, Azure™, Google Cloud™, etc., or a combination of IaaS platforms. In some embodiments, computing environment management system 300 may automatically select one or more of such IaaS platforms for deployment of a particular target infrastructure.

In one specific embodiment, computing environment management system 300 includes the HashiCorp™ Terraform platform (“Terraform™”). In this embodiment, deployment engine 110 may be implemented using the Terraform Cloud Development Kit, for compatibility with computing environment management system 300. In other embodiments, computing environment management system 300 may be an alternative infrastructure-as-code platform allowing infrastructure to be defined and provisioned using a data structure expressed in a declarative configuration language, e.g., expressed in JSON or another format.

When deployment engine 110 is implemented using the Terraform Cloud Development Kit, in some embodiments, deployment engine 110 is configured to, in a planning phase or stage, perform a pre-deployment validation operation to ensure that the deployment of the target computing environment will be in compliance with one or more predefined rules shown in FIGS. 9 and 10.

In some embodiments, a cost policy file is stored in local electronic datastore for automated implementation of pre-deployment cost control for deployment of a large computing environment. For example, deployment engine 110 implemented using Terraform™ may generate an estimated cost for deployment of the target computing environment using the data structure in output file 280, 880 as part of a planning phase; and only when the estimated cost is within a predefined cost threshold, which may be stored as part of cost policy file in a local electronic datastore, deployment engine 110 may proceed to instruct a computing environment management system to deploy the target computing environment based on the deployment data structure, in a deployment phase.

In some embodiments, a budget limit can be predefined in an existing cost policy stored locally, or can be predefined as a fixed value. As part of a pre-deployment validation operation in a planning phase, deployment engine 110 may generate an estimated cost for deployment of the target computing environment using the data structure in output file 280, 880. For example, deployment engine 110 may execute a block of code to calculate a respective cost for each type of resources required, based on a total number of each type of resources and a unit cost (e.g. hourly rate) for each type of resources. The total estimated cost may be a sum of respective costs for all types of resources required where applicable.

In some embodiments, the cost policy file can use Terraform's plan data to access resource attributes, estimate the cost of the planned resources, and compare it to the application budget.

In some embodiments, the cost policy file is executed automatically during the Terraform™ planning phase. If the policy fails (e.g. the projected cost exceeds the budget), an error message is displayed, and the deployment is not executed. This can help with keeping the cost of IT infrastructure within a predefined budget and policy for any corporation.

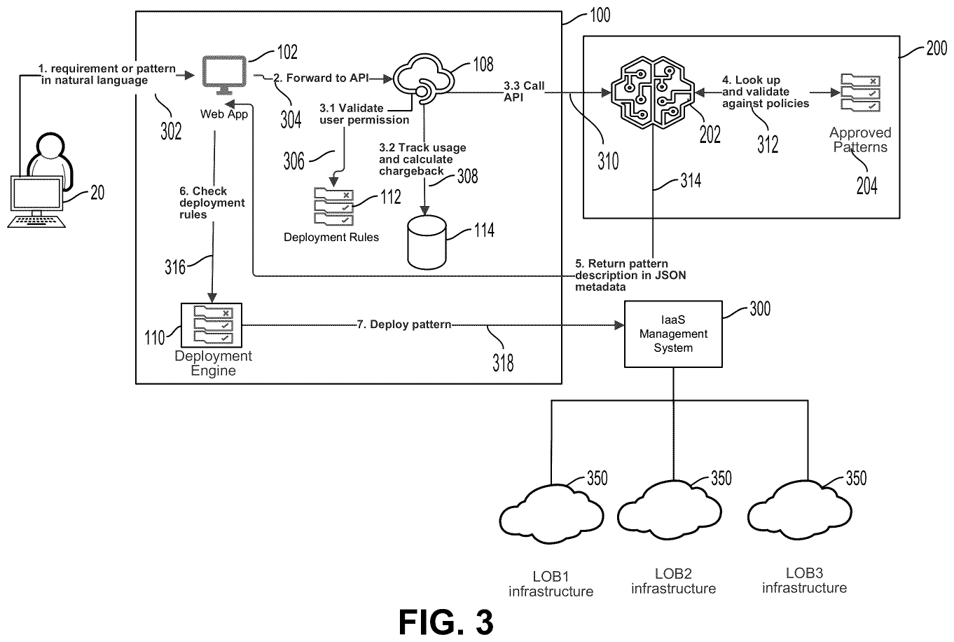

The operation of computing environment deployment system 100 is further described with reference to the system flow diagram of FIG. 3, in accordance with an embodiment.

At flow point 302, a user operating user device 20 accesses web application 102 provided at computing environment deployment system 100. By way of web application 102, the user inputs a natural language description of a target cloud infrastructure. In some cases, the natural language description may specify a particular deployment pattern to be used.

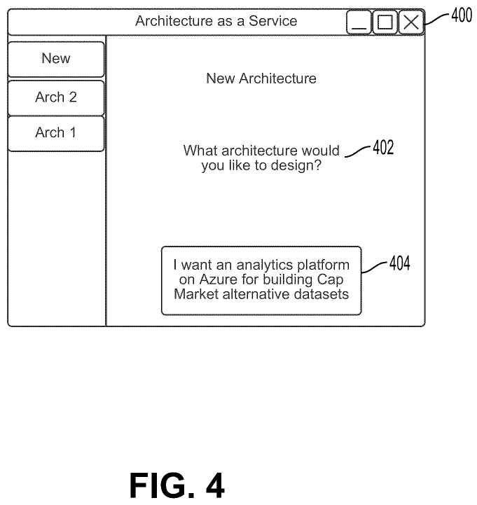

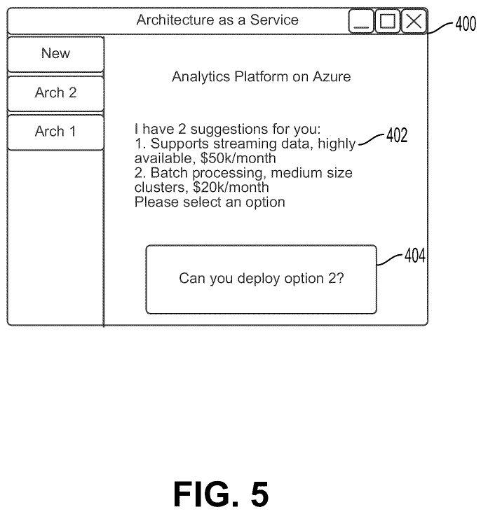

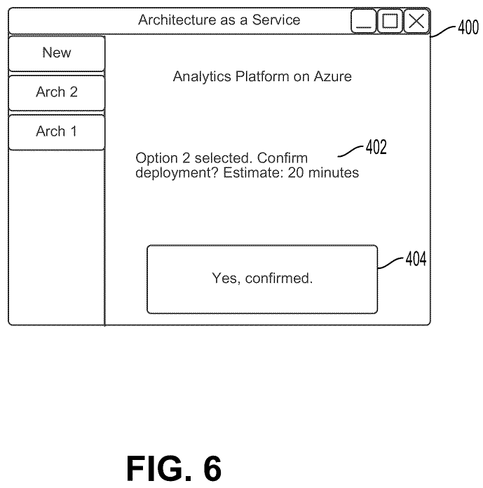

FIG. 4 is an example screen of interactive user interface 400 of web application 102, in accordance with an embodiment. As shown in this example, user interface 400 asks the user via dialog box 402 “What architecture would you like to design.” In response, the user provides a response via text input box 404: “I want an analytics platform on Azure for building Cap Market alternative datasets.” As shown, the initial description of the user's cloud infrastructure requirements can be quite brief, e.g., consisting of one or a few sentences.

Web application 102 may present follow-up questions to user, under the control of dialog engine 104. Examples of follow-up questions are shown in FIG. 5 and FIG. 6, each of which is a further example screen of interactive user interface 400. As shown in FIG. 5, user interface 400 presents a follow-up question with two deployment options via dialog box 402, and asks the user to select one of the options. The user provides a response selecting one of the options via text input box 404.

This follow-up question is generated by dialog engine 404 upon processing the initial description provided by the user (FIG. 4). The question may also be generated based on information provided by AI system 200, e.g., information about which options are available. Such information may be requested from AI system 200 by passing the initial description as a prompt to AI system 200 via API gateway 108. The question may be generated based on information provided by deployment engine 110, e.g., information regarding estimated costs associated with the two options. For some questions, dialog engine 404 may generate a follow-up question by combining information from disparate sources, namely, AI system 200 and deployment engine 110.

As shown in FIG. 6, user interface 400 presents a further follow-up question that provides information regarding an estimated deployment time, as generated by dialog engine 104, and asks the user to confirm the deployment. This estimate of deployment time may be provided to dialog engine 104 by deployment engine 110. The user provides a response with confirmation via text input box 404.

Prompt generator 106 performs prompt engineering to generate a prompt using the initial description and the response(s) to generate a prompt to the AI system 200 to request a data structure defining the target cloud infrastructure. In some cases, prompt generator 106 may generate multiple prompts for a particular deployment request, including interim prompts to obtain information required by dialog engine 104 to generate follow-up questions. In some cases, prompt generator 106 generates a prompt based on solely the initial description without any additional information from responses to follow-up questions.

In one example, the initial description is as follows:
“I need a data analytics platform leveraging Azure data lake storage services in Canada. The storage should be built according to a medallion design pattern, i.e. bronze/silver/gold layers.”

For this example, prompt generator 106 generates the following prompt:
“Analyze the following description about cloud storage, and return the these attributes: storage type, region, number of storages. Your response should be in JSON format with 3 parameters: ‘storage_type’, ‘region’, and ‘num_storages’.
I need a data analytics platform leveraging Azure data lake storage services in Canada. The storage should be built according to a medallion design pattern, i.e. bronze/silver/gold layers.”

Thus, prompt generator 106 supplements the initial description with further information regarding the target data structure to be generated by AI system 200, including the required attributes, format, and parameters corresponding to the required attributes, etc.

At flow point 304, prompt generator 106 forwards the generated prompt to API gateway 108. At flow point 306, API gateway 108 checks user permissions (as stored in a deployment rules datastore 112) to ensure that the particular user seeking to access the API of machine learning engine 200 has valid permissions to do so. At flow point 308, API gateway 108 tracks the usage by the particular user to calculate and assign a monetary cost to the user for accessing the API. The calculated monetary cost for the user may be stored in an electronic datastore 114.

In some embodiments, application user data, user role data and user role permission data and their respective corresponding user role logic rules may be stored in deployment rules datastore 112.

At flow point 310, API gateway 108 makes an API call to AI system 200. The API call includes the generated prompt, and requests AI system 200 to apply a generative model to process the prompt. The API call may identify a particular generative model of AI system 200 to be used to process the prompt. In some embodiments, the API call may be made over a secured network connection such as a VPN connection. In the depicted embodiment, the API call is made over an Azure™ ExpressRoute connection. In some embodiments, API gateway 108 calls a completions method via the API call to trigger the generation of the requested data structure.

Generative model 202 of AI system 200 processes the prompt to generate the requested data structure. The requested data structure is generated in the format identified in the prompt. The requested data structure is generated to specify the attributes identified in the prompt. At flow point 312, generative model 102 looks up and validates a design pattern described in the data structure against approved deployment patterns and/or policies stored in electronic datastore 204. In some embodiments, generative model 102 may decompose the deployment pattern described in the data structure into constituent parts and compare one or more of such parts against deployment patterns and/or policies stored in electronic datastore 204.

At flow point 314, generative model 202 outputs the generated data structure, based on the validation against approved patterns and/or policies. This data structure is returned to computing environment deployment system 100, e.g., web application 102. In some embodiments, the data structure is in a human-readable format. In some embodiments, web application 102 presents the generated data structure to the user for review and/or edits.

At flow point 316, web application 102 forwards the generated data structure to deployment engine 110, where the deployment described in the data structure is checked against deployment rules. In some embodiments, the data structure is in a string data format, and an object is instantiated at deployment engine 110 based on parsing this string data, e.g., using a command as follows:
jsonResponse=JSON.parse(response [‘choices’][0][‘text’].Istrip)

At flow point 318, the object is provided to computing environment management system 300 for deployment via one or more IaaS platforms. Computing environment management system 300 processes this object and causes the cloud infrastructure described therein to be provisioned as one or more cloud infrastructures 350. As different users utilize computing environment deployment system 100, various cloud infrastructure 350 may be provisioned, e.g., for particular users, for particular lines of business (LOB), or the like.

Once the deployment has been completed, an URL to the deployed cloud infrastructure may be returned to the user, by way of web application 102.

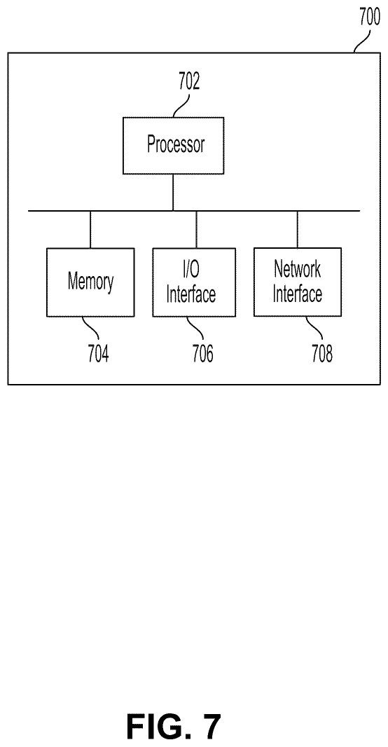

FIG. 7 is a schematic diagram of computing device 700 which may be used to implement various elements of computing environment deployment system 100, AI system 200, and computing environment management system 300. In another example, computing device 700 may be used to implement a user device 20.

As depicted, computing device 700 includes at least one processor 702, memory 704, at least one I/O interface 706, and at least one network interface 708.

Each processor 702 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 704 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 706 enables computing device 700 to interconnect with one or more input devices, such as a keyboard, mouse, camera, touch screen and a microphone, or with one or more output devices such as a display screen and a speaker.

Each network interface 708 enables computing device 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 700 is shown but one or both of system 100 and system 200 may include multiple computing devices 700. The computing devices 700 may be the same or different types of devices. The computing devices 700 may be connected in various ways including directly coupled, indirectly coupled via a network, and distributed over a wide geographic area and connected via a network (which may be referred to as “cloud computing”).

For example, and without limitation, a computing device 700 may be a server, network appliance, embedded device, computer expansion module, personal computer, laptop, smartphone device, or any other computing device capable of being configured to carry out the methods described herein.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented system for automated deployment of a computing environment, the system comprising:
a processing subsystem that includes one or more processors and one or more memories coupled with the one or more processors, the processing subsystem configured to cause the system to:
receive, from a user, a natural language description of a target computing environment;
generate a follow-up question to the user regarding a requirement of the target computing environment; and
transform the natural language description and a response to the follow-up question to a prompt for a generative model, the prompt requesting a deployment data structure defining deployment parameters of the target computing environment.

2. The computer-implemented system of claim 1, wherein the generative model includes a large language model (LLM), and the processing subsystem comprises a LLM controller configured to generate the prompt for the LLM based on an input template file.

3. The computer-implemented system of claim 2, wherein the LLM controller is configured to:
generate the follow-up question based on the input template file;
generate the prompt based on the input template file;
send the prompt to the LLM for requesting the deployment data structure defining deployment parameters of the target computing environment; and
upon receipt of an output file comprising the deployment data structure from the LLM, send the output file to a computing environment management system for deployment of the target computing environment.

4. The computer-implemented system of claim 2, wherein the LLM controller comprises a multi-agent controller configured to, in an iterative process, generate a sequence of questions to the user based on the input template file and one or more responses from the user.

5. The computer-implemented system of claim 1, wherein the target computing environment is one of: a cloud environment, a programmatically-deployable environment, or an on-premise environment.

6. The computer-implemented system of claim 1, wherein the processing subsystem is further configured to cause the system to provide the deployment data structure to a computing environment management system for deployment of the target computing environment.

7. The computer-implemented system of claim 1, wherein the generative model includes a transformer model.

8. The computer-implemented system of claim 1, wherein the deployment data structure is in a human-readable format.

9. The computer-implemented system of claim 1, wherein the processing subsystem is further configured to cause the system to:
compare an estimated cost for the deployment of the target computing environment to a predefined cost threshold; and
when the estimated cost is within the predefined cost threshold, cause a computing environment management system to deploy the target computing environment based on the deployment data structure.

10. A computer-implemented method for automated cloud deployment of a computing environment, the method comprising:
receiving, from a user, a natural language description of a target computing environment;
generating a follow-up question to the user regarding a requirement of the target computing environment; and
transforming the natural language description and a response to the follow-up question to a prompt for a generative model, the prompt requesting a deployment data structure defining deployment parameters of the target computing environment.

11. The method of claim 10, wherein the generative model includes a large language model (LLM), and the method further comprises: executing a LLM controller to generate the prompt for the LLM based on an input template file.

12. The method of claim 11, wherein executing the LLM controller comprises:
generating the follow-up question based on the input template file;
generating the prompt based on the input template file;
sending the prompt to the LLM for requesting the deployment data structure defining deployment parameters of the target computing environment; and
upon receipt of an output file comprising the deployment data structure from the LLM, sending the output file to a computing environment management system for deployment of the target computing environment.

13. The method of claim 12, wherein the LLM controller comprises a multi-agent controller, and the method comprises, in an iterative process, generating a sequence of questions to the user based on the input template file and one or more responses from the user.

14. The method of claim 10, wherein the target computing environment is one of: a cloud environment, a programmatically-deployable environment, or an on-premise environment.

15. The method of claim 10, further comprising: providing the deployment data structure to a computing environment management system for deployment of the target computing environment.

16. The method of claim 10, further comprising: generating a plurality of follow-up questions.

17. The method of claim 16, wherein the plurality of follow-up questions include a sequence of questions, wherein a subsequent question in the sequence of questions is generated based on the user's response to a prior question in the sequence of questions.

18. The method of claim 10, further comprising:
comparing an estimated cost for the deployment of the target computing environment to a predefined cost threshold; and
when the estimated cost is within the predefined cost threshold, causing a computing environment management system to deploy the target computing environment based on the deployment data structure.

19. The method of claim 10, further comprising:
providing the deployment data structure to a computing environment management system for deployment of the desired computing environment.

20. The method of claim 11, further comprising:
generating the deployment data structure using the generative model.

21. The method of claim 20, wherein said generating the deployment data structure includes:
comparing the deployment pattern defined by the deployment data structure against a library of pre-approved patterns.

22. The method of claim 10, wherein said generating the deployment data structure includes:
comparing the deployment pattern defined by the deployment data structure against a pre-defined deployment policies.

23. A non-transitory computer-readable medium or media having stored thereon machine interpretable instructions which, when executed by a processing system, cause the processing system to perform a method for automated deployment of a computing environment, the method comprising:
receiving, from a user, a natural language description of a target computing environment;
generating a follow-up question to the user regarding a requirement of the target computing environment; and
transforming the natural language description and a response to the follow-up question to a prompt for a generative model, the prompt requesting a deployment data structure defining deployment parameters of the target computing environment.
